(19) United States
(12) Patent Application Publication
(10) Pub. No.: US 2026/0073391 A1
(43) Pub. Date: Mar. 12, 2026

(54) ENHANCED DISPUTE PROTECTION

(71) Applicant: Visa International Service Association, San Francisco, CA (US)

(72) Inventors: Mark Lawrence Woelfer, Aliso Viejo, CA (US); Natalie P. England, Encinitas, CA (US); Stacey L. Jess, Byron, CA (US); Deepa Nipunage, San Jose, CA (US)

(73) Assignee: Visa International Service Association, San Francisco, CA (US)

(21) Appl. No.: 19/327,340

(22) Filed: Sep. 12, 2025

Related U.S. Application Data
(60) Provisional application No. 63/694,118, filed on Sep. 12, 2024.

(51) Int. Cl. G06Q 20/40; G06Q 20/38; H04L 61/4505

(52) U.S. Cl. CPC G06Q 20/401; G06Q 20/38215; G06Q 20/389; G06Q 20/409; H04L 61/4505

(57) ABSTRACT

A method includes a computer receiving, from an authorizing entity computer, a dispute message for a dispute comprising an interaction identifier for an interaction between a resource provider and a user. The computer determines a resource provider computer associated with the interaction identified by the interaction identifier. The computer obtains historical interaction data related to the resource provider computer and the user. The computer evaluates the historical interaction data using a plurality of rules. The computer determines an outcome based whether or not the historical interaction data satisfies a threshold number of rules of the plurality of rules. The computer provides the outcome to the authorizing entity computer.

### CROSS REFERENCE TO RELATED APPLICATIONS

This application is a non-provisional application of U.S. Provisional Application No. 63/694,118, filed on Sep. 12, 2024, which is herein incorporated by reference in its entirety.

### BACKGROUND

A user can initiate a dispute for an interaction with a resource provider if they believe that they did not conduct the interaction, and that the interaction was likely fraudulent. In this situation, a network processing computer can receive the dispute from an authorizing entity associated with the user. The network processing computer can forward the dispute to the resource provider, or an entity associated with the resource provider.

To prove that the interaction was legitimate, the resource provider needs to provide evidence to the network processing computer that the transaction was not conducted fraudulently. This requires that the resource provider maintain and store historical data, and gather the evidence that can prove that the interaction was not likely fraudulent. Further, such dispute methods require the network processing computer to communicate with the resource provider to evaluate the user's dispute, thus lengthening the amount of time needed to resolve the dispute.

Embodiments of the disclosure address this problem and other problems individually and collectively.

### SUMMARY

One embodiment is related to a method comprising: receiving, by a computer from an authorizing entity computer, a dispute message for a dispute comprising an interaction identifier for an interaction between a resource provider and a user; determining, by the computer, a resource provider computer associated with the interaction identified by the interaction identifier; obtaining, by the computer, historical interaction data related to the resource provider computer and the user; evaluating, by the computer, the historical interaction data using a plurality of rules; determining, by the computer, an outcome based whether or not the historical interaction data satisfies a threshold number of rules of the plurality of rules; and providing, by the computer, the outcome to the authorizing entity computer.

Another embodiment is related to a computer comprising: a processor; and a computer-readable medium coupled to the processor, the computer-readable medium comprising code executable by the processor for implementing operations comprising: receiving, from an authorizing entity computer, a dispute message for a dispute comprising an interaction identifier for an interaction between a resource provider and a user; determining a resource provider computer associated with the interaction identified by the interaction identifier; obtaining, from a database, historical interaction data related to the resource provider computer and the user; evaluating the historical interaction data using a plurality of rules; determining an outcome based whether or not the historical interaction data satisfies a threshold number of rules of the plurality of rules; and providing the outcome to the authorizing entity computer any of the preceding methods.

Another embodiment of the invention relates to a system. The system comprises: a network processing computer comprising, a processor, and a non-transitory computer readable medium, the non-transitory computer readable medium comprising code, executable by the processor, for implementing operations comprising, receiving, from an authorizing entity computer, a dispute message for a dispute comprising an interaction identifier for an interaction between a resource provider and a user, determining a resource provider computer associated with the interaction identified by the interaction identifier, obtaining, from a database, historical interaction data related to the resource provider computer and the user, evaluating the historical interaction data using a plurality of rules, determining an outcome based whether or not the historical interaction data satisfies a threshold number of rules of the plurality of rules, and providing the outcome to the authorizing entity computer; and a directory server in communication with the network processing computer, wherein the directory server provides at least some of the historical interaction data to the database.

Further details regarding embodiments of the disclosure can be found in the Detailed Description and the Figures.

### BRIEF DESCRIPTION OF THE DRAWINGS

FIG. 1 shows a block diagram of a system according to embodiments.

FIG. 2 shows a block diagram of components of a network processing computer according to embodiments.

FIG. 3 shows a flow diagram illustrating a dispute resolution method according to embodiments.

### DETAILED DESCRIPTION

Prior to discussing embodiments of the disclosure, some terms can be described in further detail.

A “user” may include an individual. In some embodiments, a user may be associated with one or more personal accounts and/or mobile devices. The user may also be referred to as a cardholder, account holder, or consumer in some embodiments.

A “user device” may be a device that is operated by a user. Examples of user devices may include a mobile phone, a smart phone, a card, a personal digital assistant (PDA), a laptop computer, a desktop computer, a server computer, a vehicle such as an automobile, a thin-client device, a tablet PC, etc. Additionally, user devices may be any type of wearable technology device, such as a watch, earpiece, glasses, etc. The user device may include one or more processors capable of processing user input. The user device may also include one or more input sensors for receiving user input. As is known in the art, there are a variety of input sensors capable of detecting user input, such as accelerometers, cameras, microphones, etc. The user input obtained by the input sensors may be from a variety of data input types, including, but not limited to, audio data, visual data, or biometric data. The user device may comprise any electronic device that may be operated by a user, which may also provide remote communication capabilities to a network. Examples of remote communication capabilities include using a mobile phone (wireless) network, wireless data network (e.g., 3G, 4G or similar networks), Wi-Fi, Wi-Max, or any other communication medium that may provide access to a network such as the Internet or a private network.

An “access device” may be any suitable device that provides access to a remote system. An access device may also be used for communicating with a coordination computer, a communication network, or any other suitable system. An access device may generally be located in any suitable location, such as at the location of a merchant. An access device may be in any suitable form. Some examples of access devices include POS or point of sale devices (e.g., POS terminals), cellular phones, personal digital assistants (PDAs), personal computers (PCs), tablet PCs, hand-held specialized readers, set-top boxes, electronic cash registers (ECRs), vending machines, automated teller machines (ATMs), virtual cash registers (VCRs), kiosks, security systems, access systems, and the like.

An access device may use any suitable contact or contactless mode of operation to send or receive data from, or associated with, a mobile communication or payment device. For example, access devices can have card readers that can include electrical contacts, radio frequency (RF) antennas, optical scanners, bar code readers, or magnetic stripe readers to interact with portable devices such as payment cards.

An “interaction” may include a reciprocal action or influence. An interaction can include a communication, contact, or exchange between parties, devices, and/or entities. Example interactions include a transaction between two parties and a data exchange between two devices. In some embodiments, an interaction can include a user requesting access to secure data, a secure webpage, a secure location, and the like. In other embodiments, an interaction can include a payment transaction in which two devices can interact to facilitate a payment.

“Interaction data” can include data related to and/or recorded during an interaction. In some embodiments, interaction data can be transaction data of the network data. Transaction data can comprise a plurality of data elements with data values.

A “dispute” can include a disagreement on whether a statement is true or valid. A dispute can be a disagreement on whether an interaction is fraudulent. A user can initiate a dispute on a historical transaction to indicate that the user is claiming that the historical transaction is fraudulent.

A “secure authentication system” may one or more computing devices (e.g., servers) that provide secure authentication of users with respect to transactions conducted between two entities (e.g., users and resource providers).

A “resource provider” may be an entity that can provide a resource such as goods, services, information, and/or access. Examples of a resource provider includes merchants, access devices, secure data access points, etc. A “merchant” may typically be an entity that engages in transactions and can sell goods or services, or provide access to goods or services. In some embodiments, the messages sent and/or received by the resource provider computer may be sent/received by a resource provider plug-in module that may function as a proxy between a resource provider computer and an authorizing entity computer or other components within the system.

An “acquirer” may typically be a business entity (e.g., a commercial bank) that has a business relationship with a particular merchant or other entity. Some entities can perform both issuer and acquirer functions. Some embodiments may encompass such single entity issuer-acquirers. An acquirer may operate an acquirer computer, which can also be generically referred to as a “transport computer.”

An “authorizing entity” may be an entity that authorizes a request. Examples of an authorizing entity may be an issuer, a governmental agency, a document repository, an access administrator, etc. An “issuer” may typically refer to a business entity (e.g., a bank) that maintains an account for a user. An issuer may also issue payment credentials stored on a user device, such as a cellular telephone, smart card, tablet, or laptop to the consumer. An “authorizing entity computer” may be operated by, or on behalf of, an authorizing entity. An authorizing entity computer may include an “access control server computer” that may be configured to authenticate a user.

An “access control server computer” may be configured to authenticate a user. An access control server computer can receive authentication request messages. An access control server computer may be configured to transmit challenge request messages and receive challenge response messages from a user computing device (or application operating thereon) or a service provider computer. In some embodiments, the access control server computer may be further configured to verify the enrollment of an account in a secure authentication program, perform a risk analysis to determine whether the transaction should be authenticated, and return an authentication response message to a resource provider computer (e.g., via a directory server computer).

A “directory server computer” may include a server that can perform message routing. In some embodiments, the directory server computer may be capable of receiving messages (e.g., authentication request messages, authentication response messages, etc.), determining the appropriate destination computer for the received messages, and routing the received messages to the appropriate destination computer (e.g., an access control server computer). In some embodiments, the directory server computer may include or be associated with a database containing routing tables that may be used to determine an appropriate authorizing entity computer associated with an account identifier (e.g., a bank identification number). In some embodiments, the directory server computer may be further configured to perform an enrollment verification process for an account identifier and a risk analysis process.

A “network processing computer” may include a server computer used for transaction processing. In some embodiments, the network processing computer may be coupled to a database and may include any hardware, software, other logic, or combination of the preceding for servicing the requests from one or more client computers. The network processing computer may comprise one or more computational apparatuses and may use any of a variety of computing structures, arrangements, and compilations for servicing the requests from one or more client computers. In some embodiments, the network processing computer may operate multiple server computers. In such embodiments, each server computer may be configured to process transaction for a given region or manages transactions of a specific type based on transaction data.

The network processing computer may include data processing subsystems, networks, and operations used to support and deliver authorization services, exception file services, and clearing and settlement services. An exemplary network processing computer may include VisaNet™. Networks that include VisaNet™ are able to process credit card transactions, debit card transactions, and other types of commercial transactions. VisaNet™, in particular, includes an integrated payments system (Integrated Payments system) which processes authorization requests and a Base II system, which performs clearing and settlement services. The network processing computer may use any suitable wired or wireless network, including the Internet.

The network processing computer may process transaction-related messages (e.g., authorization request messages and authorization response messages) and determine the appropriate destination computer (e.g., issuer computer) for the transaction-related messages. In some embodiments, the network processing computer may authorize transactions on behalf of an issuer. The network processing computer may also manage and/or facilitate the clearing and settlement of financial transactions.

A “transaction request message” may be an electronic message that indicates that the user has initiated a transaction with a resource provider. A transaction request message may include transaction data associated with the transaction.

A “transaction response message” may be an electronic message that is used to respond to a transaction request message. In some embodiments, the transaction response message may indicate that the transaction associated with a transaction request message was successful or unsuccessful.

“Transaction data” may include data related to a transaction. Transaction data may include data for a specific transaction, including items purchased, item prices, total cost, shipping address, billing address, payment methods (e.g., a primary account number, card number, etc.), resource provider data (e.g., merchant data), user-specific data, user computing device data, etc.

“User computing device data” may include data associated with a user computing device. User computing device data may refer to data regarding a portable computing device, such as a computer or mobile phone. Examples of user computing device data may include unique device identifiers for a computer or mobile phone, an IP address, SIM card data, application data, mobile application data, browser data, and device make and model data. User computing device data may also include the device's MSISDN, or Mobile Subscriber Integrated Services Digital Network-Number, which is a number that uniquely identifies a subscription in a mobile network.

“User-specific data” may include data specific to a user. User-specific data may include a name, mailing address, shipping address, billing address, phone number, payment account number, date of birth, marital status, income, social security number, demographic data, etc. In some embodiments, user-specific data may also include consumer preferences, notification methods, and prior transaction history.

A “challenge request message” may include a message sent as part of an authentication process for a user and/or user computing device. In some embodiments, the challenge request message may contain a request for the user to submit a pre-established authentication data in order to authenticate an account or payment device. The challenge request message may be generated and sent (e.g., by an access control server computer) prior to authenticating the account or payment device.

A “challenge response message” may include a message sent as part of an authentication process for a user and/or user computing device. In some embodiments, the challenge response message may be transmitted from a user computing device to an access control server computer or a directory server computer. The challenge response message may contain authentication data in order to authenticate an account or payment device.

“Authentication data” may include any data suitable for authenticating a user or mobile device. Authentication data may be initially obtained from a user or a device that is operated by the user. Examples of authentication data obtained from a user may include PINs (personal identification numbers), passwords, etc. Examples of authentication data that may be obtained from a device may include device serial numbers, hardware secure element identifiers, device fingerprints, biometric information of the user, phone numbers, IMEI numbers, etc.

A “token” may be a substitute value for a credential. A token may be a string of numbers, letters, or any other suitable characters. Examples of tokens include payment tokens, access tokens, personal identification tokens, etc.

A “token request indicator” may be value or flag that indicates a token is being requested.

A “payment token” may include an identifier for a payment account that is a substitute for an account identifier, such as a primary account number (PAN). For example, a token may include a series of alphanumeric characters that may be used as a substitute for an original account identifier. For example, a token “4900 0000 0000 0001” may be used in place of a PAN “4147 0900 0000 1234.” In some embodiments, a token may be “format preserving” and may have a numeric format that conforms to the account identifiers used in existing transaction processing networks (e.g., ISO 8583 financial transaction message format). In some embodiments, a token may be used in place of a PAN to initiate, authorize, settle, or resolve a payment transaction or represent the original credential in other systems where the original credential would typically be provided. In some embodiments, a token value may be generated such that the recovery of the original PAN or other account identifier from the token value may not be computationally derived. Further, in some embodiments, the token format may be configured to allow the entity receiving the token to identify it as a token and recognize the entity that issued the token.

“Tokenization” is a process by which data is replaced with substitute data. For example, a payment account identifier (e.g., a primary account number (PAN)) may be tokenized by replacing the primary account identifier with a substitute number (e.g., a token) that may be associated with the payment account identifier. Further, tokenization may be applied to any other information that may be replaced with a substitute value (i.e., token). Tokenization may be used to enhance transaction efficiency, improve transaction security, increase service transparency, or to provide a method for third-party enablement.

A “token provider computer” can be any suitable device that that services tokens. In some embodiments, a token provider computer can facilitate requesting, determining (e.g., generating) and/or issuing tokens, as well as maintaining an established mapping of tokens to values (e.g., primary account numbers (PANs)) in a repository (e.g., token vault). The token provider computer may include or be in communication with a token vault where the generated tokens are stored. The token provider computer may support token processing of transactions (e.g., payment transactions) submitted using tokens by de-tokenizing the token to obtain the original value (e.g., the PAN). In some embodiments, any suitable component of a secure authentication system may assume the roles of the token provider computer. For example, directory server computers and/or access control server computers may become a token provider by implementing the token provider services of a token provider computer according to embodiments of the present invention.

A “token cryptogram” may include a token authentication verification value (TAW) associated with a token. A token cryptogram may be a string of numbers, letters, or any other suitable characters, of any suitable length. In some embodiments, a token cryptogram may include encrypted token data associated with a token (e.g., a token domain, a token expiry date, etc.). A token cryptogram may be used to validate the token. For example, a token cryptogram may be used to validate that the token is being used within a token domain and/or by a token expiry date associated with the token.

A “token domain” may indicate an area and/or circumstance in which a token can be used. Examples of the token domain may include, but are not limited to, payment channels (e.g., e-commerce, physical point of sale, etc.), POS entry modes (e.g., contactless, magnetic stripe, etc.), and resource provider identifiers (e.g., merchant identifiers) to uniquely identify where the token can be used. A set of parameters (i.e., token domain restriction controls) may be established as part of token issuance by the token service provider that may allow for enforcing appropriate usage of the token in transactions. For example, the token domain restriction controls may restrict the use of the token with particular presentment modes, such as contactless or e-commerce presentment modes. In some embodiments, the token domain restriction controls may restrict the use of the token at a particular resource provider (e.g., a merchant) that can be uniquely identified. Some exemplary token domain restriction controls may require the verification of the presence of a token cryptogram that is unique to a given transaction. In some embodiments, a token domain can be associated with a token requestor.

“Token expiry date” may refer to the expiration date/time of the token. The token expiration date may be a numeric value (e.g., a 4-digit numeric value). In some embodiments, the token expiry date can be expressed as a time duration as measured from the time of issuance.

A “token request message” may be a message for requesting a token and/or a cryptogram. If the token request message is used to request only a cryptogram, it may be referred to as a “cryptogram request message.” A token request message may include a token requestor identifier associated with a token requestor (e.g., a directory server computer, a resource provider entity/computer, an authorizing entity/computer, or any suitable requestor). A token request message may include the payment credentials, which may be encrypted. A token request message may also include transaction data, a cryptogram, and a digital certificate (e.g., which may be signed by a key held by the token requestor), and/or any other suitable information. In some embodiments, the token request message may have an indication that it was sent by the resource provider computer on behalf of the user, and may include any suitable user information.

A “token response message” may be a message that responds to a token request message. If the token response message is used to respond only to a cryptogram request, it may be referred to as a “cryptogram response message.” A token response message may include a token requestor identifier associated with a token requestor (e.g., a directory server computer, a resource provider entity/computer, an authorizing entity/computer, or any suitable requestor) and a token and/or a token cryptogram.

A “transaction” may include an exchange or interaction between two entities. In some embodiments, a transaction may refer to a transfer of value between two users (e.g., individuals or entities). A transaction may involve the exchange of monetary funds, or the exchange of goods or services for monetary funds between two individuals or entities. In other embodiments, the transaction may be a purchase transaction involving an individual or entity purchasing goods or services from a merchant or other entity in exchange for monetary funds. In other embodiments, the transaction may be a non-financial transaction, such as exchanging of data or information between two entities, such as the transfer of data. Examples of non-financial transactions may include transactions verifying a user's age or identity (e.g., verifying identity with a government agency, verifying age for the purchase of alcohol).

An “authentication request message” may include a message sent as part of an authentication process. The authentication request message may request an authentication process be performed for a user, a user computing device, or a payment device.

An “authentication response message” may include a message sent as part of an authentication process in response to an authentication request message. An authentication response message may include the results of an authentication process based on data received in the authentication request message.

A “payment device” may include a device that can be used to perform a payment transaction. Payment device may be linked to a financial account associated with the holder of the payment device, and may be useable to provide payment information for a transaction. Payment devices can include debit devices (e.g., a debit card), credit devices (e.g., a credit card), or stored value devices (e.g., a pre-paid or stored value cards). Payment devices can also include mobile phones, tablet computers, personal digital assistants (PDAs), portable computers, smart cards, and the like. Other payment devices may include non-physical forms of payment (e.g., virtual wallets, virtual accounts).

A “verification value” may be a value or a token that indicates successful authentication. A “verification value” may be in the form of a digital signature. The digital signature may be a cryptogram that is generated after a computer such as an access control server signs transaction data with a key (e.g., a private or a symmetric key). An example of a verification value is a cardholder authentication verification value, or CAVV, that may be provided by an issuer associated with a payment device upon authentication of the payment device. The verification value may be used in processing a payment authorization for a financial transaction as proof that an issuer or other authorizing entity authenticated a user.

An “authorization request message” may be an electronic message that is sent to a transaction processing computer and/or an authorizing entity computer (e.g., issuer of a payment card) to request authorization for a transaction. An authorization request message according to some embodiments may comply with ISO 8583, which is a standard for systems that exchange electronic transaction information associated with a payment made by a consumer using a payment device or payment account. The authorization request message may include an issuer account identifier that may be associated with a payment device or payment account. An authorization request message may also comprise additional data elements corresponding to “identification information” including, byway of example only: a service code, a CVV (card verification value), a dCVV (dynamic card verification value), an expiration date, etc. An authorization request message may also comprise “transaction information,” such as any information associated with a current transaction, such as the transaction amount, merchant identifier, merchant location, etc., as well as any other information that may be utilized in determining whether to identify and/or authorize a transaction.

An “authorization response message” may be an electronic message reply to an authorization request message generated by an authorizing entity computer or a transaction processing computer. The authorization response message may include, by way of example only, one or more of the following status indicators: Approval—transaction was approved; Decline—transaction was not approved; or Call Center—response pending more information, merchant must call the toll-free authorization phone number. The authorization response message may also include an authorization code, which may be a code that an authorizing entity (e.g., an issuer bank) returns in response to an authorization request message in an electronic message (either directly or through the transaction processing computer) to a resource provider computer that indicates approval of the transaction. The code may serve as proof of authorization. In some embodiments, a transaction processing computer may generate or forward the authorization response message to the resource provider.

A “processor” may include a device that processes something. In some embodiments, a processor can include any suitable data computation device or devices. A processor may comprise one or more microprocessors working together to accomplish a desired function. The processor may include a CPU comprising at least one high-speed data processor adequate to execute program components for executing user and/or system-generated requests. The CPU may be a microprocessor such as AMD's Athlon, Duron, and/or Opteron; IBM and/or Motorola's PowerPC; IBM's and Sony's Cell processor; Intel's Celeron, Itanium, Pentium, Xeon, and/or XScale; and/or the like processor(s).

A “memory” may be any suitable device or devices that can store electronic data. A suitable memory may comprise a non-transitory computer readable medium that stores instructions that can be executed by a processor to implement a desired method. Examples of memories may comprise one or more memory chips, disk drives, etc. Such memories may operate using any suitable electrical, optical, and/or magnetic mode of operation.

A “server computer” may include a powerful computer or cluster of computers. For example, the server computer can be a large mainframe, a minicomputer cluster, or a group of servers functioning as a unit. In one example, the server computer may be a database server coupled to a Web server. The server computer may comprise one or more computational apparatuses and may use any of a variety of computing structures, arrangements, and compilations for servicing the requests from one or more client computers.

Embodiments of the disclosure allow for efficient utilization of historical interaction data to evaluate disputes between users and resource providers without needing to contact the resource providers.

One embodiment is related to a method comprising: receiving, by a computer from an authorizing entity computer, a dispute message for a dispute comprising an interaction identifier for an interaction between a resource provider and a user; determining, by the computer, a resource provider computer associated with the interaction identified by the interaction identifier; obtaining, by the computer, historical interaction data related to the resource provider computer and the user; evaluating, by the computer, the historical interaction data using a plurality of rules; determining, by the computer, an outcome based whether or not the historical interaction data satisfies a threshold number of rules of the plurality of rules; and providing, by the computer, the outcome to the authorizing entity computer.

When an authorizing entity such as issuer disputes an interaction such as transaction on behalf of a user, a network processing computer (which operates a dispute resolution process such as Visa Resolve Online (VROL)) can evaluate the disputed transaction to see if it is associated with either an authentication process and/or a token. If so, the network processing computer can search a database such as a Transaction Operational Store (TOS) for historical transactions that would meet the criteria for proving that the disputed transaction was legitimately conducted. For example, the network processing computer can search the database and obtain two historical transactions which meet a threshold number of rules. The rules may include transactions which match the IP address, the shipping address, the user identifier, or the device identifier associated with the user and/or user device that conducted the disputed transaction.

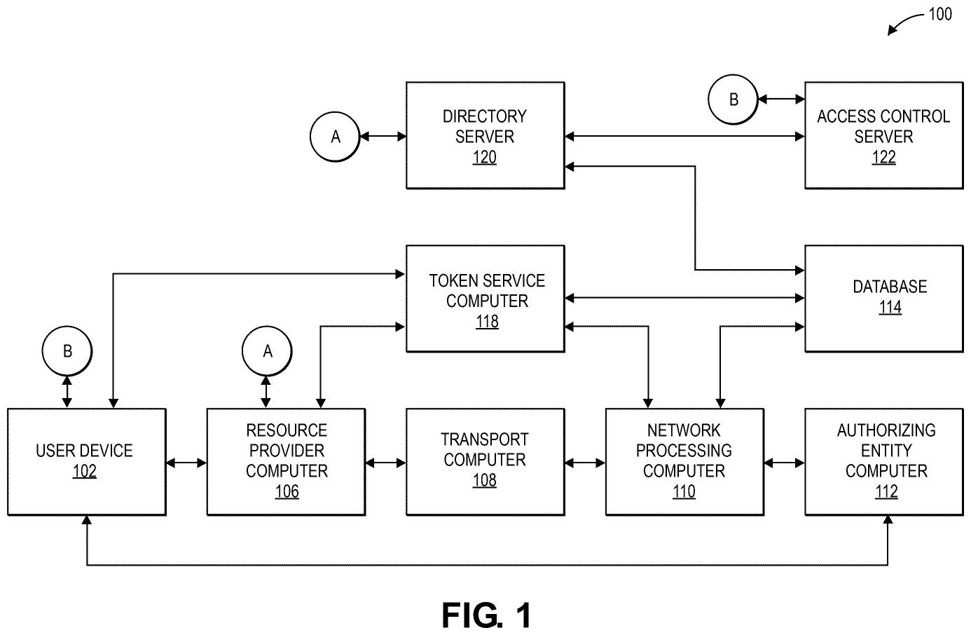

FIG. 1 shows a system 100 according to embodiments of the disclosure. The system 100 comprises a user device 102, a resource provider computer 106, a transport computer 108, a network processing computer 110, an authorizing entity computer 112, a database 114, a token service computer 118, a directory server 120, and an access control server 122.

The user device 102 can be in operative communication with the resource provider computer 106, the authorizing entity computer 112, the token service computer 118, and the access control server 122. The resource provider computer 106 operative communication with the authorizing entity computer 112 via the transport computer 108 and the network processing computer 110. The network processing computer 110 can be in operative communication with the authorizing entity computer 112, the transport computer 108, and the database 114. The token service computer 118 can be in communication with the user device 102, the resource provider computer 106, the network processing computer 110, and the database 114. The directory server 120 can be in communication with the resource provider computer 106, the database 114, and the access control server 122. In some embodiments, the network processing computer 110, the database 114, the token service computer 118, and the directory server 120 may be operated by the same entity. The entity may be a payment processing organization. In some embodiments, the authorizing entity computer 112 and the access control server 122 can be operated by the same entity. The entity may be an authorizing entity such as an issuer.

For simplicity of illustration, a certain number of components are shown in FIG. 1. It is understood, however, that embodiments of the invention may include more than one of each component. In addition, some embodiments of the invention may include fewer than or greater than all of the components shown in FIG. 1.

Messages between the devices included in the system 100 in FIG. 1 can be transmitted using a secure communications protocols such as, but not limited to, File Transfer Protocol (FTP); HyperText Transfer Protocol (HTTP); Secure Hypertext Transfer Protocol (HTTPS), SSL, ISO (e.g., ISO 8583) and/or the like. The communications network may include any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. The communications network can use any suitable communications protocol to generate one or more secure communication channels. A communications channel may, in some instances, comprise a secure communication channel, which may be established in any known manner, such as through the use of mutual authentication and a session key, and establishment of a Secure Socket Layer (SSL) session.

The user device 102 can initiate interactions (e.g., transactions) with resource provider computers. For example, the user device 102 can be a phone or a computer and access a resource provider website hosted by the resource provider computer 106.

The resource provider computer 106 can include any suitable computational apparatus operated by a resource provider (e.g., a merchant). In some embodiments, the resource provider computer 106 may include an access device and/or one or more backend server computers. In other embodiments, the resource provider computer 106 may operate a host site such as a Web site. In some embodiments, the resource provider computer 106 may be configured to send data to the network processing computer 110 via the transport computer 108 as part of a payment verification and/or authentication process for a transaction between the user (e.g., consumer) and the resource provider. The resource provider computer 106 may also be configured to generate authorization request messages for transactions between a resource provider and a user, and route the authorization request messages to the authorizing entity computer 112 for transaction processing. In some embodiments, the user device 102 can communicate with the resource provider computer 106 via the access device 104.

The transport computer 108 may be associated with an acquirer, which may be an entity (e.g., a commercial bank) that has a business relationship with a particular merchant or other entity.

The network processing computer 110 may be disposed between the transport computer 108 and the authorizing entity computer 112. The network processing computer 110 may include data processing subsystems, networks, and operations used to support and deliver authorization services, exception file services, and clearing and settlement services. For example, the network processing computer 110 may comprise a server coupled to a network interface (e.g., by an external communication interface), and databases of information. The network processing computer 110 may be representative of a transaction processing network. An exemplary transaction processing network may include VisaNet™. Transaction processing networks such as VisaNet™ are able to process credit card transactions, debit card transactions, and other types of commercial transactions. VisaNet™, in particular, includes a VIP system (Visa Integrated Payments system) which processes authorization requests and a Base II system which performs clearing and settlement services.

The authorizing entity computer 112 may be associated with an authorizing entity, which may be an entity that authorizes a request. An example of an authorizing entity may be an issuer, which may typically refer to a business entity (e.g., a bank) that maintains an account for a user. An issuer may also issue and manage an account associated with the user device 102. The authorizing entity computer 112 can receive dispute requests from the user device 102 disputing a particular historical interaction. The authorizing entity computer 112 can generate a dispute message and provide the dispute message to the network processing computer 110.

The database 114 can include any suitable database. The database 114 may be a conventional, fault tolerant, relational, scalable, secure database such as those commercially available from Oracle™ or Sybase™. The database 114 can store data related to interactions. In some embodiments, the interaction data may be provided by the directory server 120 during an authentication process and/or the token service computer 118 during a token provisioning process. The database 114 can store authentication data such as 3DS related data, token interaction related data, etc.

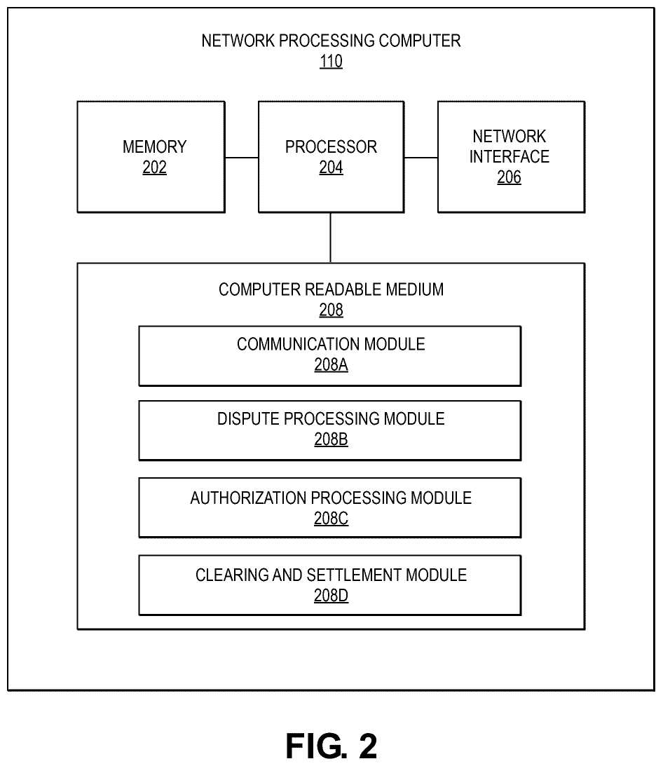

FIG. 2 shows a block diagram of the network processing computer 110 according to embodiments. The exemplary network processing computer 110 may comprise a processor 204. The processor 204 may be coupled to a memory 202, a network interface 206, and a computer readable medium 208. The computer readable medium 208 can comprise one or more modules.

The memory 202 can be used to store data and code. For example, the memory 202 can store interaction data, 3DS data, token data, user data, etc. The memory 202 may be coupled to the processor 204 internally or externally (e.g., cloud based data storage), and may comprise any combination of volatile and/or non-volatile memory, such as RAM, DRAM, ROM, flash, or any other suitable memory device.

The computer readable medium 208 may comprise code, executable by the processor 204, for performing a method comprising: receiving, by a computer from an authorizing entity computer, a dispute message for a dispute comprising an interaction identifier for an interaction between a resource provider and a user; determining, by the computer, a resource provider computer associated with the interaction identified by the interaction identifier; obtaining, by the computer, historical interaction data related to the resource provider computer and the user; evaluating, by the computer, the historical interaction data using a plurality of rules; determining, by the computer, an outcome based whether or not the historical interaction data satisfies a threshold number of rules of the plurality of rules; and providing, by the computer, the outcome to the authorizing entity computer.

The computer readable medium 208 may comprise a communication module 208A, a dispute processing module 208B, an authorization processing module 208C, and a clearing and settlement module 208D. The communication module 208A may comprise code, executable by the processor 204 to cause the network processing computer 110 to communicate with the various entities shown in FIG. 1. The dispute processing module 208B may comprise code, executable by the processor 204 to cause the network processing computer 110 to perform dispute processing. The authorization processing module 208C may comprise code, executable by the processor 204 to cause the network processing computer 110 to perform authorization processing. The clearing and settlement module 208D may comprise code, executable by the processor 204 to cause the network processing computer 110 to perform clearing and settlement processing.

The network interface 206 may include an interface that can allow the network processing computer 110 to communicate with external computers. The network interface 206 may enable the network processing computer 110 to communicate data to and from another device (e.g., a transport computer 108, an authorizing entity computer, etc.). Some examples of the network interface 206 may include a modem, a physical network interface (such as an Ethernet card or other Network Interface Card (NIC)), a virtual network interface, a communications port, a Personal Computer Memory Card International Association (PCMCIA) slot and card, or the like. The wireless protocols enabled by the network interface 206 may include Wi-Fi™. Data transferred via the network interface 206 may be in the form of signals which may be electrical, electromagnetic, optical, or any other signal capable of being received by the external communications interface (collectively referred to as “electronic signals” or “electronic messages”). These electronic messages that may comprise data or instructions may be provided between the network interface 206 and other devices via a communications path or channel. As noted above, any suitable communication path or channel may be used such as, for instance, a wire or cable, fiber optics, a telephone line, a cellular link, a radio frequency (RF) link, a WAN or LAN network, the Internet, or any other suitable medium.

The system 100 in FIG. 1 can be used to perform interactions between users and resource providers. As part of those interactions, the system 100 may also be configured to perform processing such as authentication processing and/or token provisioning processing. Data from the authentication processing and/or token provisioning processing can be automatically stored in the database 114 and can be used as historical data for future interactions. The historical data may be used in subsequent disputes between authorizing entities and resource providers. During disputes, the network processing computer 110 can apply a plurality of rules to the historical data and can arrive at outcome determinations (e.g., an adjudication) without involving the resource providers.

An authentication process and an interaction can be described with reference to FIG. 1.

The user device 102 can initiate an interaction with the resource provider computer 106. The user device 102 can provide a user identifier such as access data (e.g., a primary account number) to the resource provider computer 106. The user device 102 can also provide device data (e.g., device identifier, an IP address etc.) and other information (e.g., a shipping address) to the resource provider computer 106.

The resource provider computer 106 can generate an authentication request message comprising the data from the user device 102 and an interaction identifier (e.g., a transaction identifier). The resource provider computer 106 can provide the authentication request message to the directory server 120. The authentication request message may include data including, for example, a user identifier (e.g., a credential such as a primary account number), device data (e.g., a device identifier such as a serial number, browser data, etc.), shipping address, and/or an IP address of the user device 102.

The directory server 120 may store the data in the authentication request message in the database 114. The directory server 120 may optionally send the authentication request message to the access control server 122.

If the authentication request message is sent to the access control server 122, after receiving the authentication request message, the access control server 122 can determine an authentication decision. The access control server 122 can optionally authenticate the user of the user device 102 and/or the user device 102 itself using a separate communication channel (e.g., using the user's mobile phone) and/or may analyze the data in the authentication request message in arriving at an authentication decision. The access control server 102 could send a challenge request message to the user device 102, and the user device 102 may response with a challenge response message. The access control server 122 can evaluate the data in the challenge response message to determine if the user and/or the user device 102 are authenticated. After authenticating, the access control server 122 can send an authentication response message back to the resource provider computer 106 via the directory server 120. The directory server 120 may optionally store any data from the authentication response message in the database 114.

After receiving the authentication outcome, the resource provider computer 106 can proceed with authorization of the interaction by generating an authorization request message and providing the authorization request message to the authorizing entity computer 112 via the transport computer 108 and the network processing computer 110 for authorization. In some cases, an indicator indicating that the access control server 122 made an authentication decision can be included in the authorization request message. In other cases, no such indicator is included in the authorization request message.

Once the authorizing entity computer 112 makes an authorization decision, it can generate an authorization response message with the authorization decision. The authorizing entity computer can then transmit the authorization response message to the resource provider computer 106 via the network processing computer 110 and the transport computer 108.

At the end of the day or any other suitable period of time, a clearing and settlement process can be performed between the transport computer 108, the network processing computer 110, and the authorizing entity computer 112.

In other embodiments, the database can be populated with interaction data during a token provisioning process.

In token provisioning process, the user of the user device 102 may want to conduct an interaction with the resource provider operating the resource provider computer 106. To protect the security of the interaction, the user device 102 or the resource provider computer 106 may request a token from the token service computer 118 using a token request message. The token request message may comprise a user identifier such as credential such as a primary account number. The token request message may also comprise other information such as an interaction identifier (e.g., a transaction identifier), a user device identifier for the user device 102, an IP address of the user device 102, and a shipping address of the user of the user device 102.

After receiving the token request message, the token service computer 118 can store the information in the token request message in the database 114. The token service computer 118 may also determine a token associated with the credential. The token service computer 118 may then transmit the token to the user device 102 or the resource provider computer 106.

After receiving the token (either directly or from the user device 102), the resource provider computer 106 can proceed with authorization of the interaction by generating an authorization request message and providing the authorization request message to the network processing computer 110 via the transport computer 108. The authorization request message may comprise an interaction ID, the token, and an amount. The network transport computer 110, upon receiving the authorization request message, can communicate with the token service computer 118 to exchange the token for the credential. The network processing computer 110 can then modify the authorization request message to include the credential instead of the token. The network processing computer can then transmit the modified authorization request message to the authorizing entity computer 112 for authorization.

Once the authorizing entity computer 112 makes an authorization decision, it can generate an authorization response message with the authorization decision. The authorizing entity computer can then transmit the authorization response message to the network processing computer 110. The network processing computer 110 can then exchange the credential in the authorization response message for the token, and modify the authorization response message to include the token. The network processing computer 110 can then transmit the modified authorization response message to the resource provider computer 106 via the transport computer 108.

At the end of the day or any other suitable period of time, a clearing and settlement process can be performed between the transport computer 108, the network processing computer 110, and the authorizing entity computer 112.

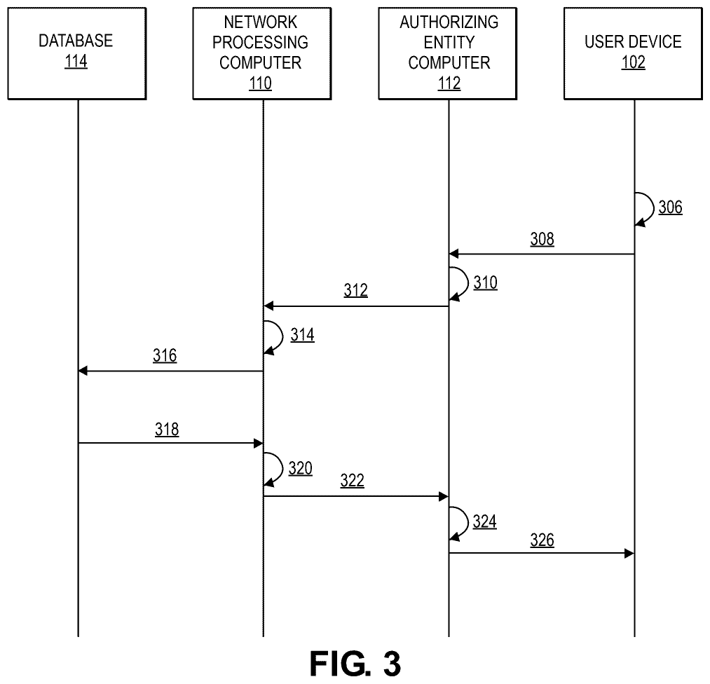

FIG. 3 shows a flow diagram illustrating a dispute resolution method according to embodiments.

During an interaction between a resource provider of the resource provider computer 106 and a user of the user device 102, interaction related data (e.g., authentication data, transaction data, etc.) can be stored to the database 114 as described above. The database 114 can store any data related to the interaction (e.g., a user identifier, an interaction identifier, a shipping address, an IP address, a user device ID, etc.).

At a later point in time, at step 306, the user device 102 can generate a dispute request message that disputes a particular interaction (e.g., the interaction described above). The user of the user device 102 can claim that the interaction was fraudulent and that they did not conduct the interaction. The dispute request message can include an interaction identifier that identifies the interaction.

At step 308, the user device 102 can provide the dispute request message to the authorizing entity computer 112.

At step 310, after receiving the dispute request message, the authorizing entity computer 112 can analyze the dispute request message. If the authorizing entity computer 112 does not have sufficient information to resolve the dispute (e.g., decline the dispute), then the authorizing entity computer 112 can generate a dispute message comprising at least the interaction identifier.

At step 312, the authorizing entity computer can provide the dispute message to the network processing computer 110 to determine interactions conducted between the user and the resource provider.

At step 314, the network processing computer 110 can determine a resource provider computer associated with the interaction identified by the interaction identifier. The network processing computer 110 can determine whether or not the resource provider computer is enrolled in the system where the interaction data related to interaction involving the resource provider computer is stored in the database 114 for dispute resolution.

If the resource provider computer is enrolled, then the network processing computer 110 can generate a query for historical interaction data related to the resource provider and the user using, for example, a resource provider identifier and a user identifier.

At step 316, the network processing computer 110 can provide the query for the historical interaction data to the database 114.

At step 318, the database 114 can return data based on the query to the network processing computer 110.

At step 320, after obtaining the historical interaction data related to the resource provider computer and the user, the network processing computer 110 can evaluate the historical interaction data using a plurality of rules. The plurality of rules can include any number of rules. For example, one rule can be that two previous interactions between the user and the resource provider need to involve the same primary account number associated with the user. Another rule can be that the two previous interactions need to have been completed between the user and the resource provider within the last X number of days (e.g., 30 days, 60 days, 365 days, etc.). Another rule can be that at least two core data elements (e.g., user identifier, shipping address, IP address, user device identifier/fingerprint, etc.) match between prior interactions and the disputed interaction.

After evaluating the historical interaction data using the plurality of rules, the network processing computer 110 can determine an outcome based whether or not the historical interaction data satisfies a threshold number of rules of the plurality of rules. For example, if the historical data satisfies a threshold number of rules (e.g., 2 rules, 3 rules, etc.) then the disputed interaction is not fraudulent as it has similarities to the historical interactions based on the rules.

If the historical interaction data satisfies the threshold number of rules, then the network processing computer 110 can determine that the disputed interaction is not fraudulent and that the dispute is to be denied. If the historical interaction data does not satisfy the threshold number of rules, then the network processing computer 110 can determine that the disputed interaction is fraudulent and that the dispute is to be accepted.

At step 322, the network processing computer 110 can provide the outcome to the authorizing entity computer 112.

At step 324, the authorizing entity computer 112 can evaluate the outcome.

At step 326, the authorizing entity computer 112 can provide the outcome to the user device 102 in a dispute response message in response to the dispute request message.

Embodiments of the disclosure have a number of advantages. For example, a resource provider computer does not need to maintain and store historical interaction data in the case of a user disputing an interaction. The resource provider computer is not required to be involved during a disputed interaction. Embodiments of the invention can be useful in friendly fraud cases in which a person (e.g., a child), other than the user (e.g., a parent) may have conducted a transaction that the user was not aware of. The user may mistake the interaction as being fraudulent when it is in fact legitimate. In such situations, the resource provider would not need to actively collect the data to prove that the interaction was legitimate. Therefore, embodiments reduce the amount of time taken to evaluate and resolve interaction disputes.

Although the steps in the flowcharts and process flows described above are illustrated or described in a specific order, it is understood that embodiments of the invention may include methods that have the steps in different orders. In addition, steps may be omitted or added and may still be within embodiments of the invention.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g., a hard drive, a CD, or an entire computer system), and may be present on or within different computer products within a system or network. A computer system may include a monitor, printer, or other suitable display for providing any of the results mentioned herein to a user.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

As used herein, the use of “a,” “an,” or “the” is intended to mean “at least one,” unless specifically indicated to the contrary.

What is claimed is:

1. A method comprising:
receiving, by a computer from an authorizing entity computer, a dispute message for a dispute comprising an interaction identifier for an interaction between a resource provider and a user;
determining, by the computer, a resource provider computer associated with the interaction identified by the interaction identifier;
obtaining, by the computer from a database, historical interaction data related to the resource provider computer and the user;
evaluating, by the computer, the historical interaction data using a plurality of rules;
determining, by the computer, an outcome based whether or not the historical interaction data satisfies a threshold number of rules of the plurality of rules; and
providing, by the computer, the outcome to the authorizing entity computer.

2. The method of claim 1, wherein the computer is a network processing computer.

3. The method of claim 1, wherein the outcome indicates that the dispute is denied or accepted.

4. The method of claim 1, wherein the historical interaction data related to the resource provider and the user relates to an authentication process involving the user.

5. The method of claim 1, wherein in the interaction, the user operates a user device, and the resource provider operates the resource provider computer.

6. The method of claim 1, wherein the historical interaction data related to the resource provider and the user relates to a token provisioning process.

7. The method of claim 1, wherein the plurality of rules comprises a rule requiring that a predetermined number of interactions be conducted between the resource provider and the user within a predetermined time period.

8. The method of claim 7, wherein the plurality of rules comprises a rule requiring that within the predetermined number of interactions, two or more of the following data elements match in the interactions in the predetermined number of interactions: a user identifier, device data, shipping address, or an IP address.

9. The method of claim 8, wherein the device data comprises a device identifier.

10. The method of claim 8, wherein the device data that is scraped from a user device operated by the user.

11. The method of claim 8, wherein the user identifier is a credential.

12. The method of claim 8, wherein determining the outcome and providing the outcome does not involve the resource provider.

13. The method of claim 1, wherein the historical interaction data related to the resource provider computer and the user relates to an authentication process involving the user conducting a current interaction with the resource provider computer operated by the resource provider or a token provisioning process, and wherein the method further comprises:
receiving, by the computer from the resource provider computer, an authorization request message comprising access data;
transmitting, by the computer the authorizing entity computer, the authorization request message;
receiving, by the computer from the authorizing entity computer, an authorization response message; and
transmitting, by the computer to the resource provider computer, the authorization response message.

14. The method of claim 13, wherein the authentication process comprises:
receiving, by a directory server from the resource provider computer, an authentication request message comprising the access data, the interaction identifier, and a plurality of data elements associated with the interaction; and
storing, by the directory server, in the database, the access data, the interaction identifier, and the plurality of data elements associated with the interaction.

15. The method of claim 13, wherein the access data comprises a token, and wherein the token provisioning process comprises:
receiving, by a token service computer from a user device operated by the user or the resource provider computer operated by the resource provider, a token request message comprising a credential, the interaction identifier, and a plurality of data elements associated with the interaction;
storing, by the directory server, in the database, the credential, the interaction identifier, and the plurality of data elements associated with the interaction; and
transmitting, by the token service computer, a token response message to the resource provider computer or the user device.

16. The method of claim 1, further comprising:
receiving, by the computer, an authorization request message comprising a token and an amount;
determining, by the computer using a token service computer and the token, a credential;
modifying, by the computer, the authorization request message to include the credential instead of the token; and
transmitting, by the computer to the authorizing entity computer, the modified authorization request message comprising the credential for authorization of the interaction.

17. A computer comprising:
a processor; and
a non-transitory computer readable medium, the non-transitory computer readable medium comprising code, executable by the processor, for implementing operations comprising:
receiving, from an authorizing entity computer, a dispute message for a dispute comprising an interaction identifier for an interaction between a resource provider and a user;
determining a resource provider computer associated with the interaction identified by the interaction identifier;
obtaining, from a database, historical interaction data related to the resource provider computer and the user;
evaluating the historical interaction data using a plurality of rules;
determining an outcome based whether or not the historical interaction data satisfies a threshold number of rules of the plurality of rules; and
providing the outcome to the authorizing entity computer.

18. The computer of claim 17, wherein the plurality of rules comprises a rule requiring that a predetermined number of interactions be conducted between the resource provider and the user within a predetermined time period, and
wherein the plurality of rules comprises a rule requiring that within the predetermined number of interactions, two or more of the following data elements match in the interactions in the predetermined number of interactions: a user identifier, device data, shipping address, or an IP address.

19. A system comprising:
a network processing computer comprising,
a processor, and
a non-transitory computer readable medium, the non-transitory computer readable medium comprising code, executable by the processor, for implementing operations comprising,
receiving, from an authorizing entity computer, a dispute message for a dispute comprising an interaction identifier for an interaction between a resource provider and a user,
determining a resource provider computer associated with the interaction identified by the interaction identifier,
obtaining, from a database, historical interaction data related to the resource provider computer and the user,
evaluating the historical interaction data using a plurality of rules,
determining an outcome based whether or not the historical interaction data satisfies a threshold number of rules of the plurality of rules, and
providing the outcome to the authorizing entity computer; and
a directory server in communication with the network processing computer, wherein the directory server provides at least some of the historical interaction data to the database.

20. The system of claim 19, further comprising:
a token service computer in communication with the network processing computer,
wherein the token service computer provides at least some of the historical interaction data to the database.
